(19) United States
(12) Patent Application Publication
(10) Pub. No.: US 2003/0220875 A1
(43) Pub. Date: Nov. 27, 2003

(54) Method and system for invoice routing and approval in electronic payment system

(76) Inventors: Duc Lam, San Jose, CA (US); Xuan (Sunny) McRae, Fremont, CA (US)

Correspondence Address: WILSON SONSINI GOODRICH & ROSATI, 650 PAGE MILL ROAD, PALO ALTO, CA, 943041050

(21) Appl. No.: 10/155,853

(22) Filed: May 24, 2002

(51) Int. Cl. G06F 17/60

(52) U.S. Cl. 705/45

(57) ABSTRACT

A method for effecting a transaction between two parties. A system for effecting a transaction between two parties. Electronic data regarding management relationships between respective employees at one of the parties is received. An electronic document related to the transaction is received from the other party. An interface is provided through which users can take actions with respect to documents. The actions include authorization of invoices and applying signatures to checks. A notification regarding the document is sent to an electronic mail account of a user who is responsible for at least an aspect of the transaction, and if the user does not take a particular action within a particular period, the invoice is automatically sent to the user's manager as determined based on the electronic data. According to various implementations, the electronic data comprises data loaded from a human resources management system, and the document comprises an invoice and the particular action comprises approval of the invoice. The user may comprise the employee who ordered goods that are included in the transaction. The signatures may comprise digital signatures effected with a private key.

### REFERENCE TO RELATED APPLICATIONS

This application is related to the following United States patent applications filed of even date herewith:

Method and System for Collaborative Vendor Reconciliation, application Ser. No. ______, invented by Duc Lam, Georg Muller, Chandra (CP) Agrawal, Baby Lingampalli, Pavel Lopin and Xuan (Sunny) McRae, attorney docket number 25923.703;

System and Method for Electronic Authorization of Batch Checks, application Ser. No. ______, invented by Duc Lam, Matthew Roland and Xuan (Sunny) McRae, attorney docket number 25923.704;

System and Method for Varying Electronic Settlements between Buyers and Suppliers with Dynamic Discount Terms, application Ser. No. ______, invented by Don Holm, Duc Lam and Xuan (Sunny) McRae, attorney docket number 25923.705;

System and Method for Electronic Payer (Buyer) Defined Invoice Exchange, application Ser. No. ______, invented by Duc Lam, Ramnath Shanbhogue, Immanuel Kan, Bob Moore and Xuan (Sunny) McRae, attorney docket number 25923.706; and

Method and System for Buyer-Centric Dispute Resolution in Electronic Payment System, application Ser. No. ______, invented by Duc Lam, Celeste Wyman and Xuan (Sunny) McRae, attorney docket number 25923.708.

All of the foregoing applications are incorporated herein by reference in their entirety.

### BACKGROUND OF THE INVENTION

1. Field of the Invention This invention relates to the field of software and computer network systems. In particular, the invention relates to electronic systems associated with financial transactions.

2. Description of the Related Art

In traditional paper payment systems, an organization or an individual initiates payment by sending a physical check to the party to whom a debt is owed. The check may be sent in response to an invoice from the party to whom the debt is owed. A newer approach is electronic payment. For example, in the consumer context, individuals may be able to make payment by way of electronic banking. Payment instructions are sent electronically from the individual's computer system to the individual's bank. Payment is then effected by the bank.

Numerous systems now exist relating to accounting and bill payment. For example, computer software is used to track invoices and print payment checks. Payments may be made by wire transfer, with instructions requesting funds of the payer in one financial institution to be transferred to an account of the party to whom payment is to be effected.

Enterprise resource planning (ERP) systems are used for managing the purchases of goods and services. Such systems may have databases of complex and extensive sets of information, such as addresses of various suppliers and similar information related to purchasing. Sellers also use electronic accounting and record keeping systems which may assist in the receipt and tracking receipt of payment for goods and services. Prior systems require considerable amounts of effort to update and maintain, and may lack compatibility with the systems used by parties with whom an organization wishes to engage in transactions. There is thus a need for improved systems to facilitate transactions between buyers and sellers.

### SUMMARY

An embodiment of the invention is directed to a method for effecting a transaction between two parties. Electronic data regarding management relationships between respective employees at one of the parties is received. An electronic document related to the transaction is received from the other party. An interface is provided through which users can take actions with respect to documents. The actions include authorization of invoices and applying signatures to checks. A notification regarding the document is sent to an electronic mail account of a user who is responsible for at least an aspect of the transaction, and if the user does not take a particular action within a particular period, the invoice is automatically sent to the user's manager as determined based on the electronic data.

According to various implementations, the electronic data comprises data loaded from a human resources management system, and the document comprises an invoice and the particular action comprises approval of the invoice.

The user may comprise the employee who ordered goods that are included in the transaction.

The signatures may comprise digital signatures effected with a private key.

One implementation includes automatically displaying the documents in a user interface listing the documents wherein the display is based on priority. The documents may be prioritized based on discount day. Also, the documents may be prioritized based on the due date.

According to one implementation, an identification of a contact person is received, and if the person is not found, automatically routing notification to an account for the contact person's department. If the department is not found, notification is automatically routed to an account for an accounts payable department.

According to another implementation, if the document is an invoice and it matches an open purchase order, it is determined whether prices in the invoice are within a range of tolerances associated with the purchase order and the invoice is automatically approved if prices in the invoice are within the tolerances.

### BRIEF DESCRIPTION OF THE DRAWINGS

FIG. 1 is a block diagram of a system for electronic payment according to an embodiment of the invention.

FIG. 2 is a flow diagram for routing of information for electronic payment according to an embodiment of the invention.

FIG. 3 is a state diagram of a routing of information for electronic payment according to an embodiment of the invention.

FIG. 4 is a flow diagram for routing of information and approval process according to an embodiment of the invention.

FIG. 5(a) is a flow diagram for routing of information where a contact person may not be found in an electronic payment system according to an embodiment of the invention.

FIG. 5(b) is a flow diagram for routing of information in response to a periodic time event in a payment system according to an embodiment of the invention.

FIG. 6(a) is a flow diagram for receipt and acknowledgement of PO-based invoices in an electronic payment system according to an embodiment of the invention.

FIG. 6(b) is a flow diagram for invoice receipt and acknowledgement in an electronic payment system according to an embodiment of the invention.

FIG. 7 is a flow diagram for automatic invoice approval in an electronic payment system according to an embodiment of the invention.

FIG. 8 is a class diagram for automatic routing of documents in an electronic payment system according to an embodiment of the invention.

FIG. 9 is a block diagram of an electronic payment system according to an embodiment of the invention.

### DETAILED DESCRIPTION

An embodiment of the invention is directed to a system for routing documents in an electronic payment system. When the documents reach a particular status, certain actions are taken. The documents are routed in order to allow users to take certain actions upon the documents and, as a result, the status of the documents changes. The documents are routed to the appropriate users using email notification. The routing includes, according to different embodiments of the invention, routing of notification of invoice receipt confirmations, invoice authorizations, check signings, check approval and check endorsement. Accordingly, invoice documents and checks are routed to various users for users to take appropriate actions on them.

Notifications are sent as emails regarding different types of documents. Steps are taken in order to find the proper list of documents awaiting particular types of actions. The proper group of users to receive the documents or notifications regarding the documents is determined, and the documents are mapped to each respective user. The notifications are sent to these users based on the mapping, and after the action is taken by the user on the document, the document is marked as completed with respect to such action.

One embodiment of the invention is directed to the routing of invoices for approval and authorization of payment for the respective transaction. An invoice is received from a seller and routed to different employees or agents in the buyer organization for acknowledgement, approval and authorization of payment. The routing takes place through sending the invoice by email along with links in the email to user interfaces that allow the users to take the appropriate actions. The invoices may be routed, according to an embodiment of the invention, to the respective employees responsible for the goods or services that were ordered. If the employee does not respond or if additional approval is needed, the invoice or other document is routed to a different employee, such as the employee's manager, according to an established hierarchy. The hierarchy, according to one embodiment of the invention, is determined based on human resource data imported from a human resource management system.

The company human resource data is initially imported into the system through a file. Such file may comprise an XML file. Later, the data is periodically synchronized with the human resource data. Such synchronization takes place nightly according to one embodiment of the invention. An optional user maintenance page allows an administrator to manually update such user data without waiting for the synchronization process.

One embodiment in the invention is directed to routing of check documents. Checks are routed to various employees in the organization through routing of electronic documents. The respective employee or employees whose approval or signature of the check is needed receive a notification regarding the check. The employee then approves, or if requested by the system, signs the check with a digital signature. For some checks, the system receives an additional signature from another employee, such as a higher-level manager. The system routes the check to the appropriate additional employee.

According to one embodiment of the invention, routing is based on a generic framework that is able to handle different patterns of routing with different routing rules for different types of documents. Such different types of documents may be for example, check documents or invoice documents. From the user's point of view, the routing, according to one embodiment of the invention, is driven by a set of database configurations.

Invoices may be routed for receipt confirmation or for authorization. Such actions may happen in sequence or in parallel. Both receipt confirmation or authorization may require multiple or single signatures. According to one embodiment of the invention, certain invoices are automatically approved without routing if they meet particular rules for automatic approval. Such rules may be based on the supplier, item, amount, frequency, or the combination or sub-combination of such factors. Alternatively, automatic approval may be based on the dollar amount for the invoice in addition to the number of days left for payment.

The routing may follow the organization's management levels for escalation. For exceptions, routing may be made to the accounts payable (AP) department. When a set of signatures is required, a similar number of notifications may be sent to the respective individuals whose signatures are required. For example, when N level signatures are required, each notification may be sent to N levels of target people at the same time. Escalation may occur after a certain number of cutoff days. For example, if an employee to whom a notification has been sent has not acted upon the notification within a particular number of days, a notification may be sent to the employee's manager or other party in the hierarchy to whom items are intended to be sent if the respective employee does not act accordingly.

Invoices may be prioritized automatically based on the time remaining until they are due. This time remaining determines whether it is likely that a discount can be obtained and the amount of such discount for early payment. Invoices may also be automatically prioritized based on the due date. Alternatively, invoices are manually prioritized. Invoices are presented to the user in the order of priority. Alternatively, invoices are shown in different colors according to the priority.

From the notification email, the user may be led directly to a data page from which the user can take action on the invoice. If the invoice is configured to be posted after routing, the invoice is sent to the enterprise resource planning (ERP) system for posting after it is approved. Alternatively, if the invoice is already posted to the ERP system before routing, then a status change is sent to the ERP system to indicate that the invoice has been approved.

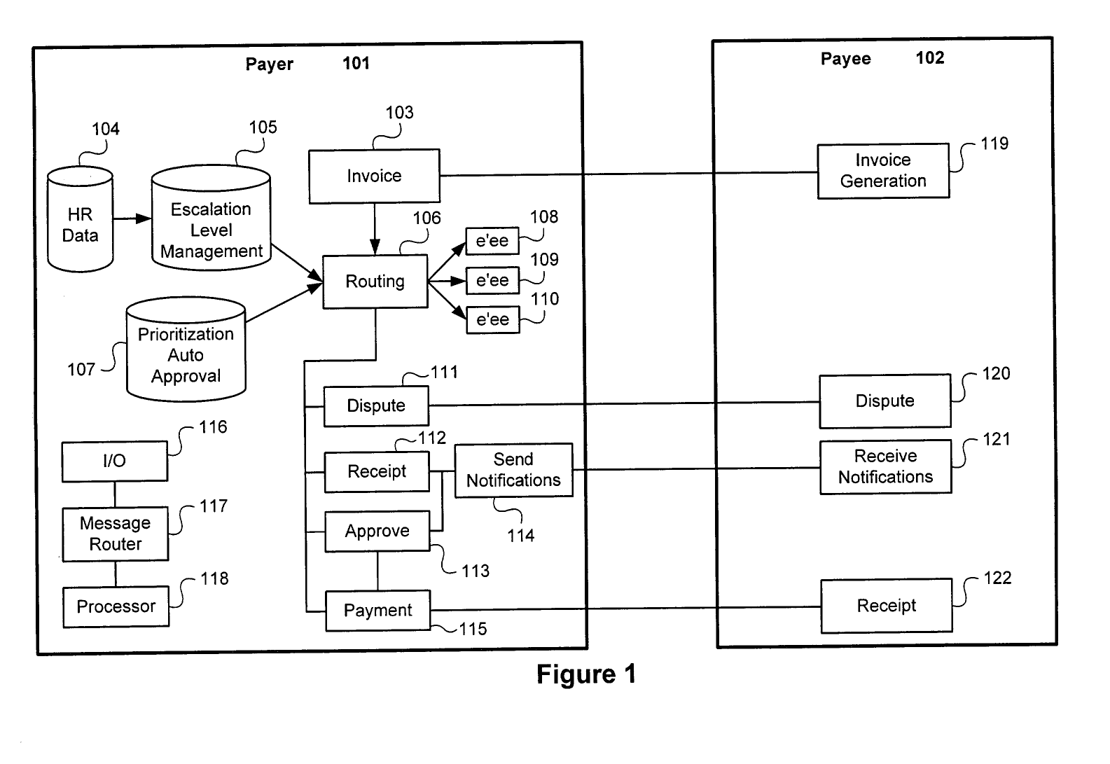

FIG. 1 is a block diagram of a system for electronic payment according to an embodiment of the invention. FIG. 1 shows an electronic payment system, which includes payer system 101 and payee system 102. Payer system 101 includes generated invoice 103, routing logic 106, dispute logic 111, receipt logic 112, approve logic 113, payment logic 115 and send notifications logic 114. Payer system 101 also includes employee logic 108, 109 and 110. Payer logic includes HR data 104, escalation level management information 104 and prioritization auto-approval information 107. Invoice 103 of payer system 101 is received into routing logic 106. Routing logic 106 is in communication with employee logic 108, 109, and 110. Routing logic 106 also has access to escalation levels management hierarchy 105, which is coupled with HR data 104. Additionally, routing logic 106 has access to prioritization and auto-approval scheme 107. Routing logic 106 is also in communication with dispute logic 111, receipt logic 112 and approve logic 113.

Payer system 101 is implemented on a computer system with various processes implementing the respective functions shown. As such, payer system includes appropriate computer hardware such as processor 117, message router 117 and input/output (I/O) 116. Message router 117 may comprise appropriate software that allows for email notifications or other messages to be routed internally in payer system 101 and to the respective recipients.

Payee system 102 includes invoice generation logic 119, dispute logic 120, receive notifications logic 121 and receipt logic 122. Invoice generation logic 119 is in communication with invoice 103 of payer system 101. Dispute logic 120 is in communication with dispute logic 111 of payer system 101. Receive notifications logic 121 is in communication with send notification logics 114 of payer system 101, and receipt logic 122 of payee system 102 is in communication with payment logic 115 of payer system 101.

An invoice is generated by payee system 102 by invoice generation logic 119. The invoice may be generated based on an invoice definition provided by the payer. Such invoice definition may have a set of rules regarding respective fields for the invoice and content for those fields. The invoice is routed by routing logic 106 to the respective recipients. Routing logic 106 routes the invoice to respective employees via employee logic 108, 109 and 110. Routing is made to different employees and may be escalated to their managers based on respective hierarchical data retained in escalation level management scheme 105. Such escalation level management scheme is created based on human resource data, according to one embodiment of the invention. Human resource data is stored in HR database 104. Such data is periodically updated from a human resource management system of the organization. Such updates may occur periodically such as on a nightly basis. HR database is a separate database in a separate human resources management system (HRMS) according to one implementation.

The employees may take various actions upon the invoice or other document. For example, an employee may acknowledge receipt of, approve or reject an invoice. In response to a dispute of an invoice, a dispute is optionally started and a dispute communication is managed by dispute logic 111. Accordingly, dispute logic is in communication with corresponding dispute logic 120 or payee system 102 in order to allow for communication regarding the disputed item. Receipt of invoice or other documents by the respective employee or employees is acknowledged by receipt logic 1112. A corresponding notification may be sent to the payee by sender notification logic 114, which sends a notification to the respective logic receive notifications 121 of payee system 102. In the event that an invoice is approved, approve logic 113 sends in cooperation with the send notification logic 114 sends a notification to payee system 102.

After approval of an invoice, payment may be effected. Payment is effected by payment logic 115. Payment logic may include logic to generate checks or to cause settlement of payment electronically between payer system 101 and payee system 102. Accordingly, payment logic 115 is in communication with the receipt logic 122 of payee system 102.

A check may also be routed by routing logic 106. A check is generated based on a set of instructions from an employee or automatically generated based on approval of payment. The check is routed to appropriate employees and presented to them for payment by the appropriate software logic, such as employee logic 108, 109 and 110. Upon approval and signing of the check, the check is disbursed by payment logic 115.

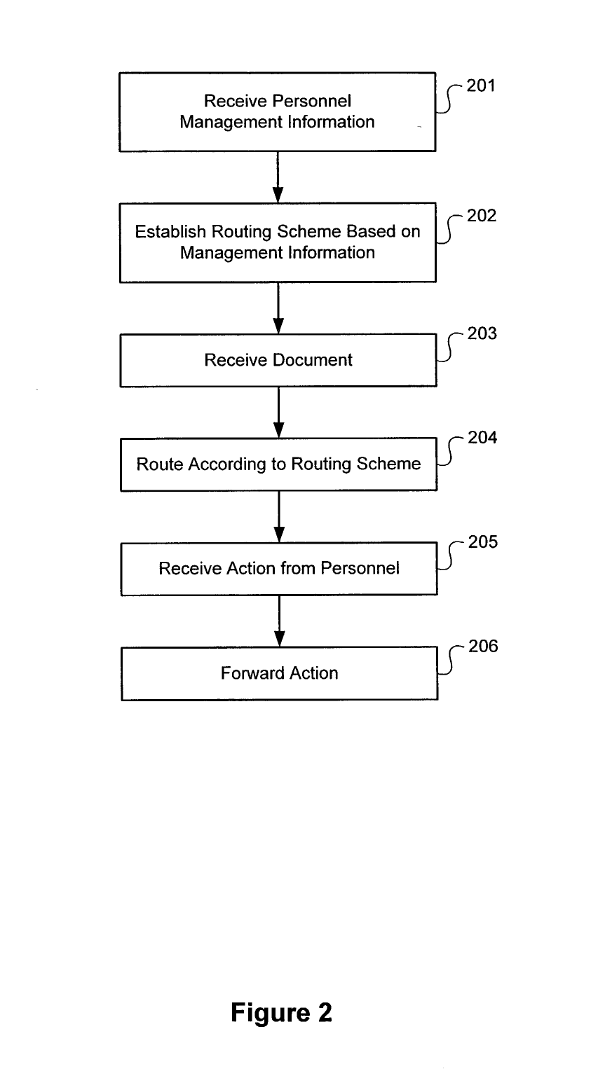

FIG. 2 is a flow diagram for routing of information for electronic payment according to an embodiment of the invention. An embodiment in the invention is directed to a method of routing a document according to a scheme based on management information. Personnel management information is received (block 201). Such personnel management information may be received from a human resource management system (HRMS). Such data may be extracted from a file from the HRMS system. Then the information is translated into a form that provides the appropriate hierarchical information for escalation of request for action. Accordingly, an invoice routing scheme based on the management information that's established (block 202). In a system in which other documents are routed such as checks, the appropriate routing scheme for such documents is established based on the management information. A document is then received (block 203).

The document is then routed according to the established scheme (block 204). In such routing, the document is routed to the appropriate personnel. An action is received from the personnel to whom the document is routed (block 205). Such action may be received from personnel other than the first personnel to whom the document is routed. For example, no action may be received after a period of time and then the document may be automatically routed to another employee, for example, based on escalation levels within the management hierarchy. Alternatively, actions from multiple employees may be required and such actions are received. Accordingly, the action is received from personnel (block 205). This action is forwarded appropriately (block 206). For example, an approval of an invoice may be forwarded to appropriate logic in the system to further process the invoice and settle payment. Additionally, a notification based on the approval of the invoice may be forwarded to the seller in order for the seller to take actions based on the approval. For example, based on the approval, the seller may finance advanced payment from a third party. Alternatively, the seller may agree to receive a discounted payment in exchange for receiving such payment at a time earlier than would otherwise be required.

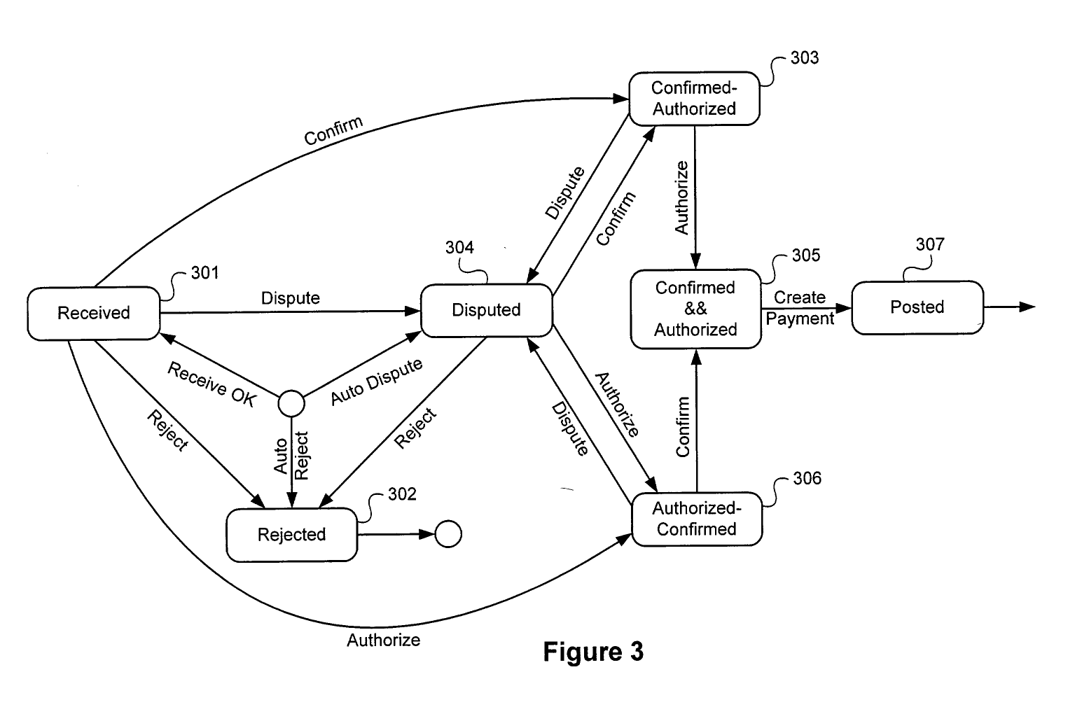

FIG. 3 is a state diagram of a routing of information for electronic payment according to an embodiment of the invention. Upon a successful receipt, an invoice moves to state received (state 301). Upon an automatic rejection, an invoice moves directly to a rejected state (state 302). Upon an automatic dispute, an invoice moves directly to a disputed state (state 304). Received invoice (state 301) moves to confirmed, but not authorized (state 303) in response to a confirmation. In response to a dispute, an invoice moves from received (state 301) to disputed (state 304). In response to an authorization, an invoice moves from received (state 301) to authorized, but not confirmed (state 306). An invoice moves from received (state 301) to rejected (state 302) upon a rejection. A rejection is an end stop for an invoice, according to this state diagram.

A disputed invoice (state 304) moves to a rejected state (state 302) upon a rejection of the disputed invoice. Upon a confirmation, a disputed invoice (state 304) moves to confirmed, but not authorized (state 303). Upon an authorization, a disputed invoice (state 304) moves to authorized but not confirmed (state 306). An invoice that is confirmed but not authorized (state 303), upon a dispute, moves to dispute (state 304). An invoice that is authorized but not confirmed (state 306) moves to disputed (state 304) upon a dispute.

An invoice that is confirmed but not authorized (state 303) upon authorization, moves to being confirmed and authorized (state 305). An invoice that is authorized but not confirmed (state 306), upon confirmation, moves to being confirmed and authorized (state 305). An invoice that is confirmed and authorized (state 305) can then be paid. Such invoice is then posted for payment (state 307).

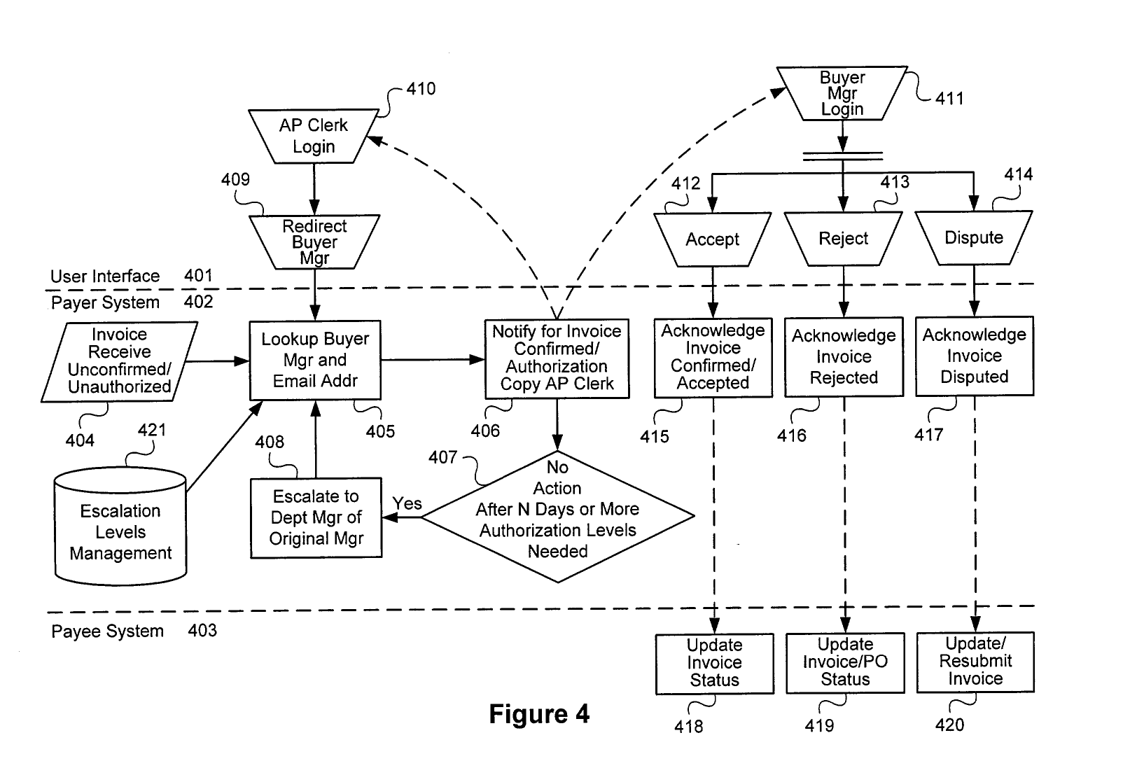

FIG. 4 is a flow diagram for routing of information and approval process according to an embodiment of the invention. FIG. 4 shows a path of routing for a document and the corresponding notifications. An invoice that is received valid by the system but does not qualify for automatic approval is routed for manual receipt confirmation. Receipt confirmation and authorization routing are performed in parallel according to one embodiment of the invention. First, a notification is routed to the contact at the buyer who is designated to receive information regarding the order. If the contact does not take action within some number of days of the notification, the system automatically escalates notification to another individual. This other individual may be the department manager of the original contact at the buyer.

The system allows both the contact at the buyer and managers to define groups of acting people who are able to receive notifications for them according to an embodiment of the invention. Such acting users also have the permission to perform confirmation according to an embodiment of the invention. Under one implementation, such notifications are set to the original contact and the acting contact at the same time. Additionally, notification is copied to the accounts payable (AP) clerk. Such notification is sent in one implementation in parallel with notification to the respective contact at the buyer.

The contact receives a notification with a hyperlink. The hyperlink allows the contact person to see a list of invoices to be confirmed. The contact person can accept, can reject or dispute the respective invoice or other document. The system sends acknowledgements to the supplier depending on the action taken by the user.

FIG. 4 shows actions at the user interface 401, internal processing of the payer system 402 and the payee system 403. An invoice is received in an unconfirmed or unauthorized state (block 404). The contact person at the payer and the email of that person is looked up (block 405). A notification is sent to the respective contact person regarding the invoice (or other document) (block 406). A copy is sent to the accounts payable (AP) clerk. Thus, the AP clerk is able view the notification during login (block 410) and the contact person at the payer (buyer manager) is able to view the notification at login (block 411).

If the buyer contact does not take action after a particular number of days (such as n days or more) or more authorization is needed (block 407), then the notification is escalated (block 408). The escalation is made according to a set of escalation levels stored in a management data structure 421. That is, the respective manager or additional person who is to provide authorization is looked up (block 405) using such database 421. A notification is then sent to the respective manager or contact person (block 406).

The accounts payable (AP) clerk takes action by logging in to the system (block 410). The accounts payable (AP) clerk can redirect notification to a different contact person or manager (block 409). In such redirection, the appropriate contact person or manager and their email address is looked up (block 405).

The contact person or manager takes action by logging in to the system (block 411). Upon such login, the contact person or manager is able to view the notifications that have been sent for that contact person's or manager's review (sent from block 406). The contact person takes an action on the document through the user interface 401. Such action is selected among accept (block 412), reject (block 413) and dispute (block 414). If the action is to accept, an acknowledgement is received to confirm or authorize the invoice or other document (block 415). In response, an update of the invoice status is sent to the payee system (block 418). If the action is to reject the invoice or the other document (block 413), an acknowledgement is received to reject the invoice or other document (block 416). In response the payee's response, payee system 403 is updated with the new status of rejected (block 419). If the action is to dispute the invoice or other document (block 414), the dispute action is acknowledged and the invoice is updated to disputed status (block 417). In response, an update regarding the disputed status of the invoice or other document is sent to payee system 403 (block 420).

When the buyer system properly receives an invoice or document, the invoice or other document is routed to a contact person for the contact person to acknowledge receipt of the invoice or other document. If the contact person is not found, another individual is found and the invoice or other document is routed to that individual. The administrator can choose different routing rules which determine who are the target group of users to whom notification emails are sent to. In cases where no user takes action on the invoice within a number of cutoff days, the routing automatically escalates to the next higher level according to one embodiment of the invention. Where not enough organizational data is available for a such automatic escalation, the system switches to a manual routing mode and sends an appropriate notification to the accounts payable (AP) clerk for a decision from the clerk as to whom the invoice or other document should be redirected.

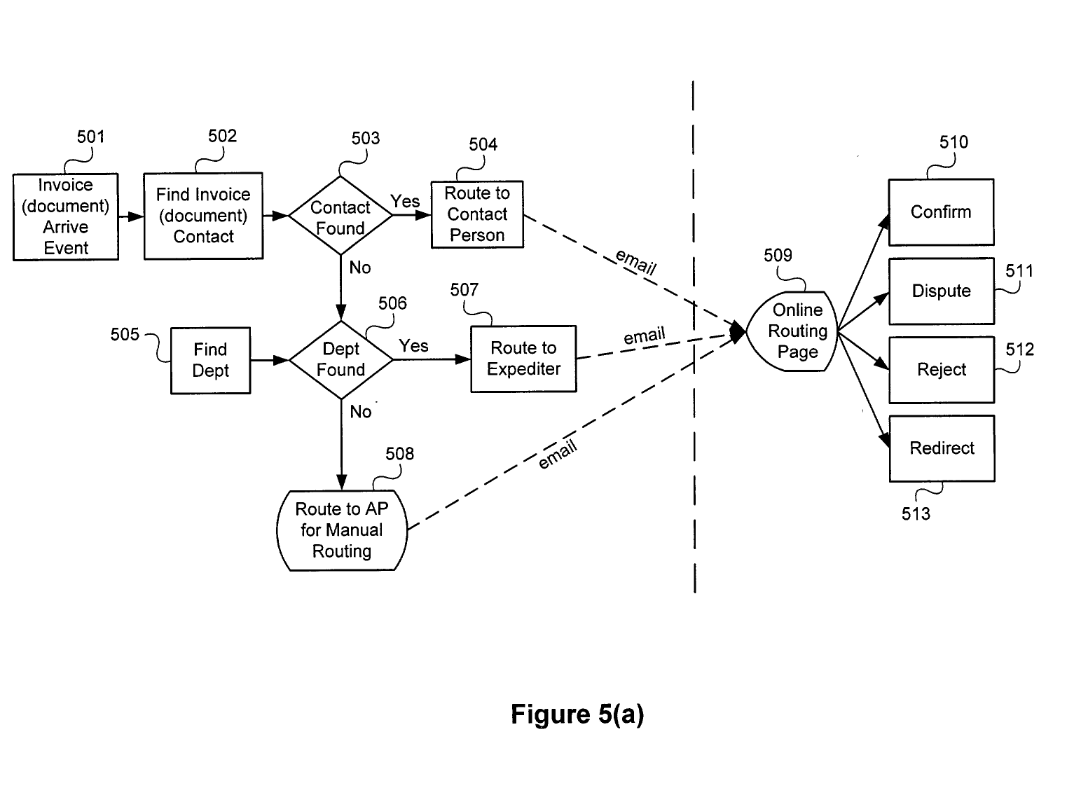

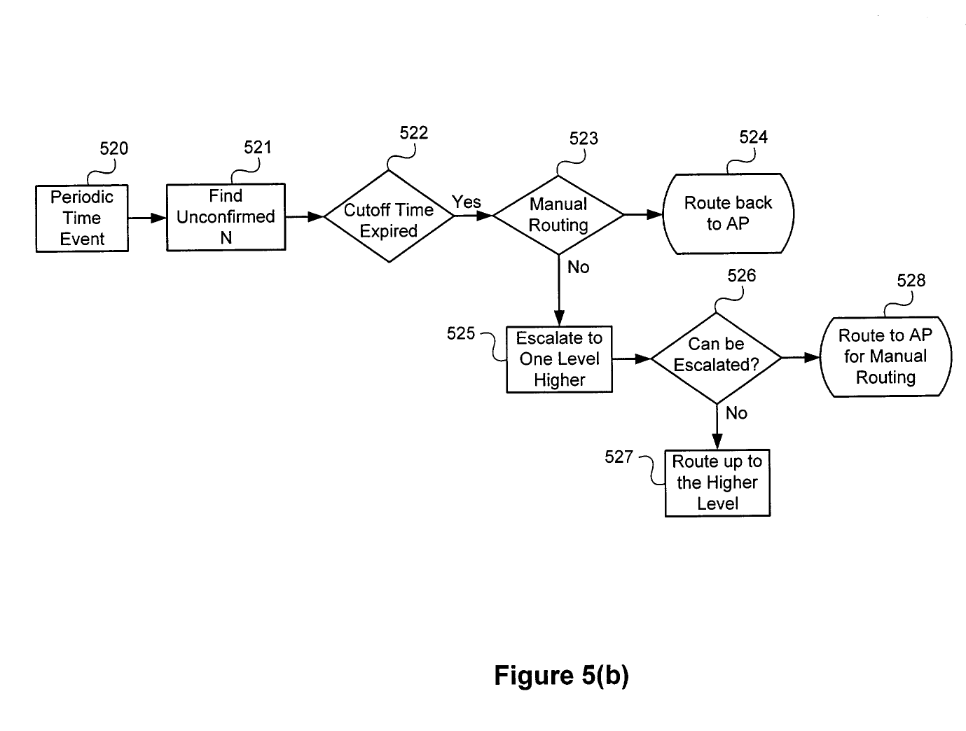

For example, FIG. 5(a) is a flow diagram for routing of information where a contact person may not be found in an electronic payment system according to an embodiment of the invention. First an invoice or other document is received (block 501). The system searches for the appropriate contact person for the invoice (block 502). If the contact is found (block 503), then the invoice or other document is routed to that person (block 504). Such routing takes place via email. Then the contact person is able to take an action at an online routing page (block 509). The system allows the user to take an action such as confirmed the invoice or other document (block 510), dispute the invoice or other document (block 511), reject the invoice or other document (block 512) or redirect the invoice or other document (block 513).

If the contact person is not found (block 503), an attempt is made to find the department corresponding to the contact person (block 505). If the department is found (block 506), the invoice or other document is routed to an expeditor associated with the department (block 507). An email is sent to such to an expediter, and the expediter can take action on the online routing page (block 509). If the department is not found (block 506), the invoice or other document is routed to accounts payable (AP) for manual routing. An email is sent and the accounts payable manager is able to take action on the online routing page (block 509). The accounts payable person can take an action such as confirmed (block 510), dispute (block 511), reject (block 512), or redirect (block 513). Taking the action redirect (block 513) allows the accounts payable person to manually redirect the invoice or other document to another person, given that the contact person and department were not found.

FIG. 5(b) is a flow diagram for routing of information in response to a periodic time event in a payment system according to an embodiment of the invention. A period time event is received by the system (block 520). Such periodic event may take place daily for another time basis selected in order to optimally verify that contact persons have taken the requested actions on invoices or other documents. The invoices or other documents that have not been confirmed or for which other required actions have not been taken are found (block 521). If a required cutoff time has expired for such document (block 522), then it is determined whether manual routing has been set up for this type of document (block 523). If manual routing has been setup, then the invoice or other document is routed back to accounts payable (AP) (block 524).

If manual routing is not required (block 523), then the invoice or other document is escalated to one higher level (block 525). If escalation fails (block 526), then the invoice or other document is routed to accounts payable (AP) for manual routing (block 528). If the item can be escalated (block 526), then it is routed to the appropriate other contact person such as the manager of the contact person.

A single invoice may correspond to multiple purchase orders. The invoice contains contact information for the respective employee at the buyer that came from the respective purchase order. According to one implementation, if a purchase order referred to in an invoice does not match any open purchase order in the buyer system's records, the invoice is automatically rejected. According to a feature in one implementation, if the buyer user has set up a range of price tolerances for the price in an invoice based on the respective price in the corresponding purchase order, then an invoice is acknowledged as meeting these criteria if the criteria are satisfied. According to one implementation, if an invoice that has been previously disputed as resubmitted, and the price amount is above the tolerance amount, the invoice is acknowledged as having been received successfully. However, the buyer has the option to later dispute the invoice.

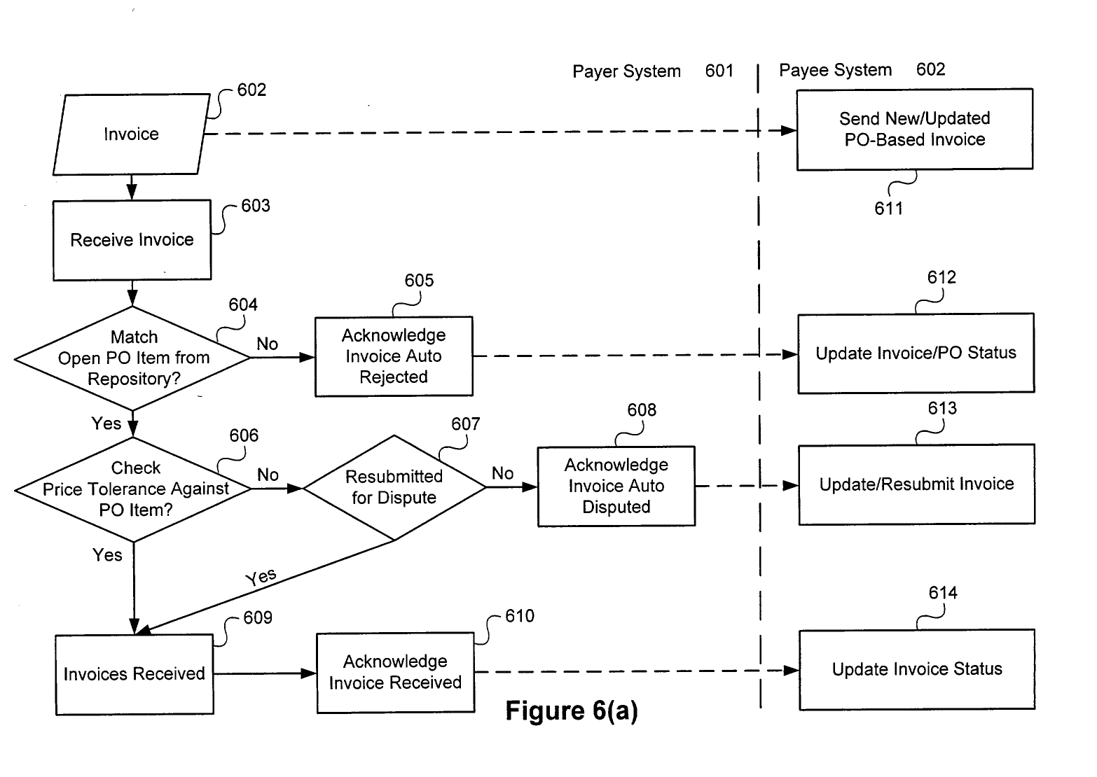

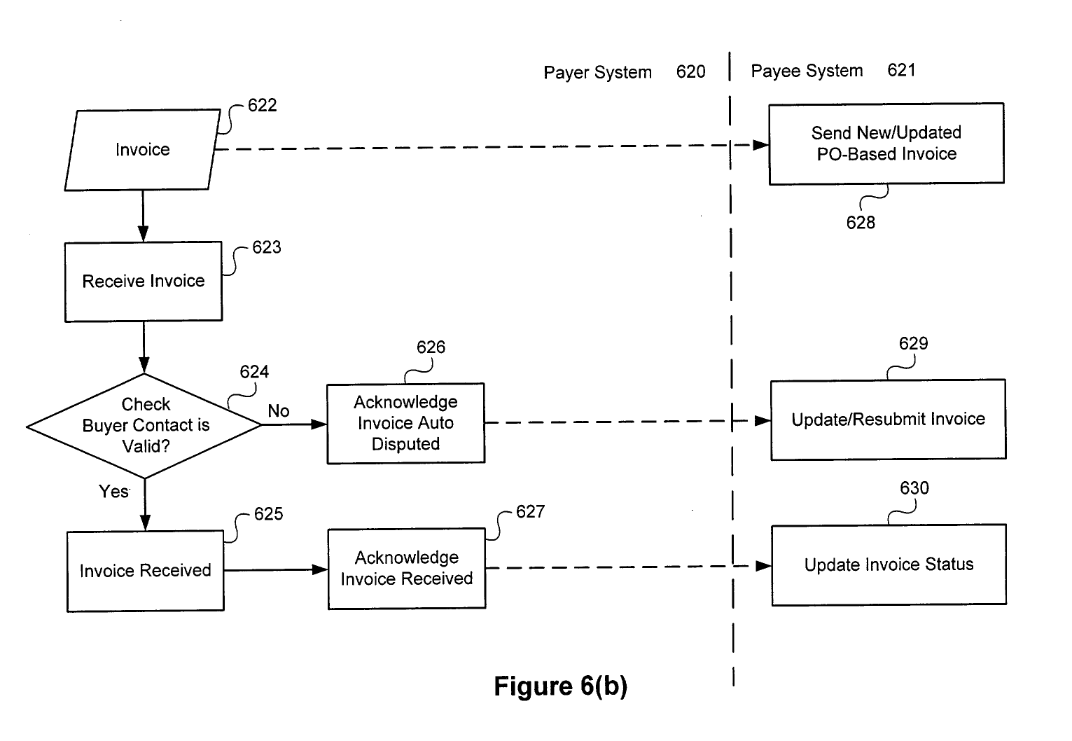

FIG. 6(a) illustrates some of these concepts. FIG. 6(a) shows interaction payer system 601 and payee system 602. Payment system 602 sends a new or updated purchase order-based invoice to payer system 601 (block 611). Invoice 602 is received at payer system 601 (block 603). If the invoice does not match a purchaser order item from a repository of purchase orders made by the payer system (block 604), then an acknowledgment of the invoice is sent automatically rejecting the invoice (block 605). The payee system updates the invoice status based on the acknowledgment (block 612).

If the invoice does match an opened purchase order stored in the repository of a payer system 601 (block 604), then a check is made as to whether the respective prices in the invoice are within the particular price tolerance set forth such items (block 606). If the invoice has not been resubmitted for dispute (block 607), then an automatic acknowledgment is sent that the invoice is disputed for such item not being within tolerance (block 607). In response, payee system 602 updates the status of the invoice accordingly (block 613). If the invoice has been resubmitted for dispute (block 607), it is determined to be received (block 609). After receipt of the invoice (block 609), an acknowledgment of receipt of the invoice is sent (block 610). Payee system 602 correspondingly updates the status of the invoice (block 614). If the price of the item is within the particular price tolerance (block 606), then the invoice is placed in a received status (block 609). Then the invoice is acknowledged as received (block 610). In response to such acknowledgment, payee system 609 updates the status of the invoice accordingly (block 614).

FIG. 6(b) is a flow diagram for invoice receipt and acknowledgement in an electronic payment system according to an embodiment of the invention. FIG. 6(a) shows interaction between the payer system 620 and payee system 621. The payee system 621 sends a new or updated non-purchase order based invoice to payee system 620 (block 628). The payer system 620 receives this invoice 622 (block 623). Payer system 620 checks whether the buyer contact name in the invoice is a valid contact (622). If the contact name is not valid, an invoice acknowledgment is sent automatically disputing the invoice (block 626). In response, payee system 621 updates the status of the invoice accordingly and possibly resubmits the invoice (block 629).

If the buyer contact is valid (block 624), the invoice is placed in a received status (block 625). An acknowledgment of the receipt of the invoice is sent to payee system 621 (block 627). In response, payee system 621 updates the status of the invoice accordingly (block 630).

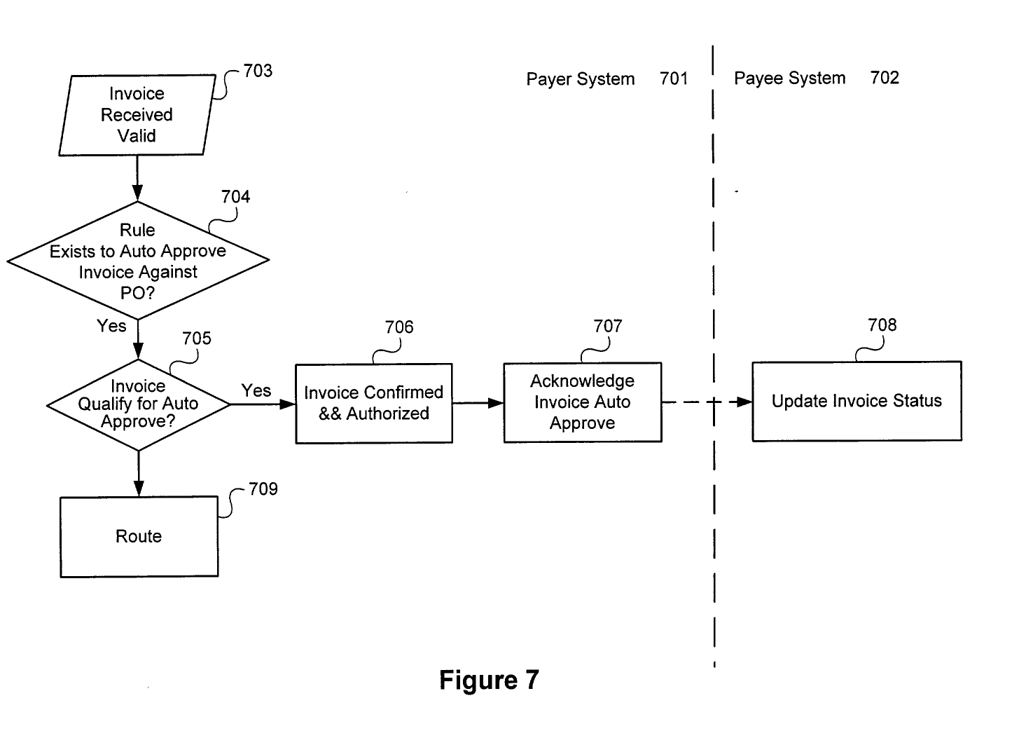

FIG. 7 is a flow diagram for automatic invoice approval in an electronic payment system according to an embodiment of the invention. A certain types of invoices may be automatically confirmed and/or authorize by the system according to different implementations. If an invoice is received validly by the system and also satisfies the conditions for automatic approval, the invoice is approved automatically without being routed to individuals for manual approval. The conditions for automatic approval are based, according to different implementations, on supplier, product and amount.

First, it is assumed that an invoice is validly received at payer system 701 from payee system 702 (block 703). If a rule exists to automatically approve an invoice against a purchase order (block 704), then it is determined whether the particular invoice qualifies for automatic approval (block 705). Such the criteria for automatic approval may include whether the invoice is from a preferred supplier, whether the invoice is for a recurring product or service and/or whether the invoice item price is within a selected tolerance of the amount in the corresponding purchaser order. If it does not meet the criteria for automatic approval (block 705), then the invoice is routed to the appropriate contact persons for approval (block 709). If the invoice does meet the criteria for automatic approval (block 705), then the invoice is automatically confirmed and authorized (block 706). Next, the invoice is acknowledged and automatically approved (block 707). In response, payee system 702 updates the invoice status accordingly to note the acknowledgment and approval of the invoice (block 708).

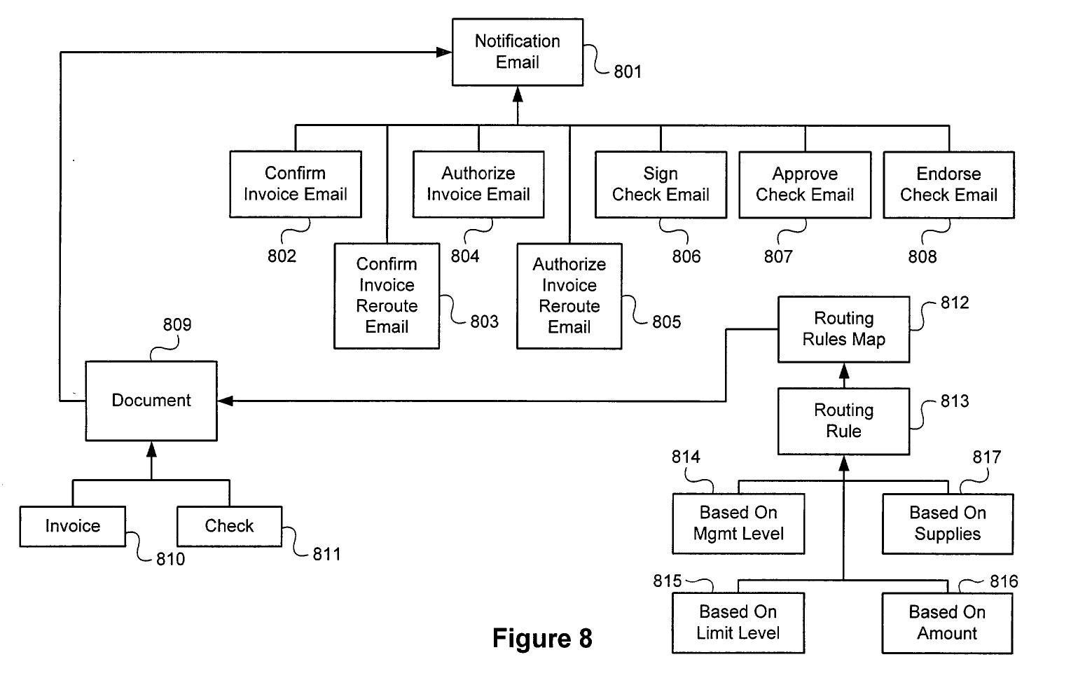

FIG. 8 is a class diagram for automatic routing of documents in an electronic payment system according to an embodiment of the invention. The routing system is based on a generic framework with adapters for handling different types of email notifications, different types of documents and different user configurable routing rules. Human resource hierarchical data is imported into the system database for a hierarchy of automatic routing escalations. The class framework, according to one embodiment of the invention, has at least two levels of classes: an abstract level that deals with common processing for different notifications and for different documents; and a concrete of implementation level that provides specific implementation for particular types of notification, document and/or routing rule. The major classes in the routing and notification framework include notification email, document and routing rules. The email types are mapped to the routing rules as follows: if an escalation routing rule is defined for the email type, then the email is generated based on the escalation routing rule. If the escalation routing rule fails, or if a rule is not defined for escalation, then manually route the document to a finance clerk, such as an accounts payable (AP) clerk. The finance clerk then reroutes the document to other contact persons. When an action is not taken as expected, an email is sent back to the clerk again.

The class diagram of FIG. 8 includes a notification email type 801 which includes confirm invoice email 802, confirm invoice reroute email 803, authorize invoice email 804, authorize invoice reroute email 805, sign check email 806, approve check email 807 and endorse check email 808. The notification email class 801 includes documents, map of documents to respective users, and a method to send the notification. According to one embodiment of the invention, a notification involves the following:

getting the respective document (such as the invoice or a check or other document).

automatically escalating the notification if required. Automatic escalation involves determining the user to whom to escalate using the escalation hierarchy, which is received from human resource data, mapping the user to the respective documents, creating an email for the notification to the user, and sending the email.

manual rerouting if escalation is not available. Manual escalation involves determining the user to whom to escalate to. This user may be an accounts payable (AP) clerk. Also involve is mapping the user to the respective document to be routed, creating an email to send the document and notification and sending the email.

The types of emails sent include confirming that an invoice was received (confirmed invoice email 802), confirming than an invoice is to be rerouted (confirmed invoice reroute mail 803), authorizing an invoice (authorized invoice email 804), authorizing a rerouting of an invoice (authorized invoice reroute email 805), signing a check (signed check email 806), approving a check (approved check email 807) and endorsing a check (endorsed check email 806). Each email provides a notification that the user is requested to decide whether to take the respective action with respect to the associated document. The user is then able to make such decision and take an action in the system corresponding to such decision. For example, when a user receives an authorization invoice email 804, the user is presented with a choice to authorize the respective invoice. If the user authorizes the invoice in response to the email, the system then sets the status of the respective invoice as authorized by the respective user. If a user receives a signed check email 806, then the user is presented with an option to sign the respective check document. If the user signs the check, the status of the check document is updated to reflect that the user has signed and the digital signature of the user is added to the check. When the respective actions request have been taken, then the document is marked as done by an appropriate method. The status of document is changed accordingly.

The class structure includes type document 809 which includes type invoice 810 and type check 811. A document has a status, an associated routing rules map, and attribute as to regarding autosend (TS) and manualsend (TS), and appropriate attributes to carry out such functions.

A type routing rules map 812 is associated with each respective document. The routing rules map has associated rule 813 that determine how the document is routed. The rule may be based on the management level (based on management level), based on a limit (based on limit level 815), based on the amount of the invoice or check (based on amount 816), and/or based on the supplier (based on supplier 817).

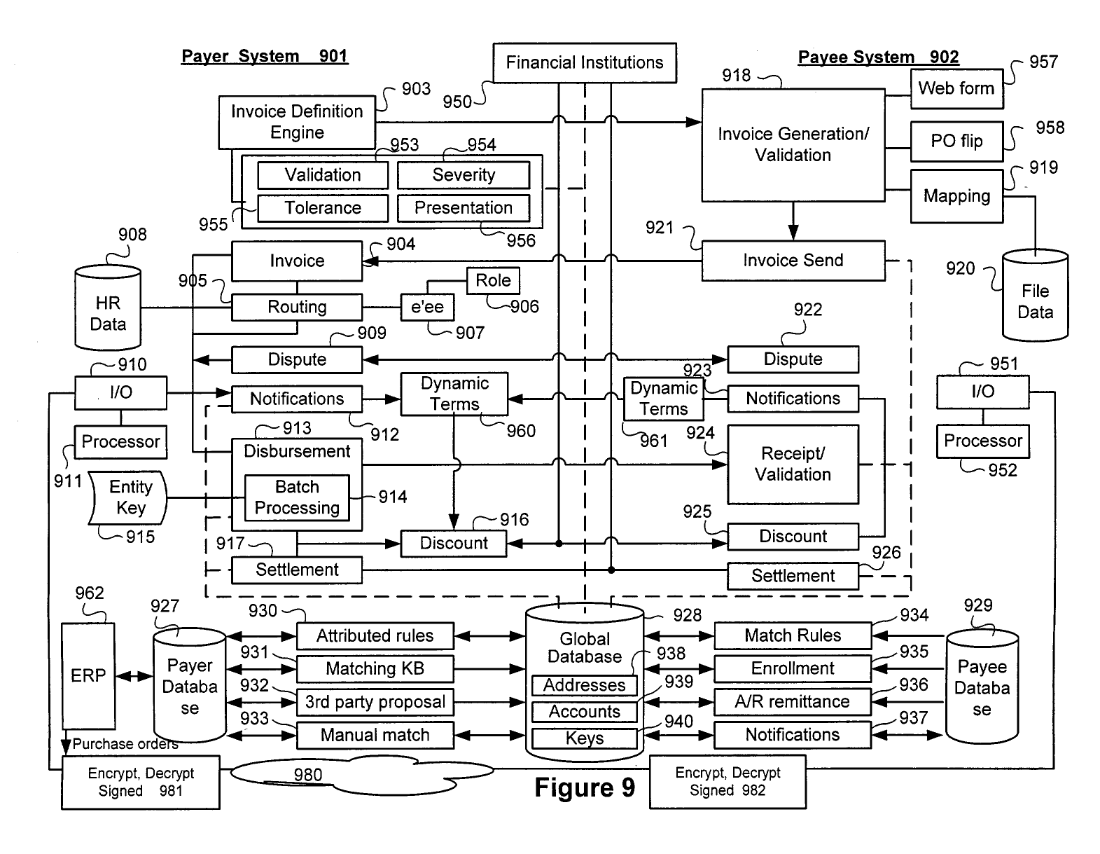

FIG. 9 is a block diagram of a system according to an embodiment of the invention. The system allows a paying entity to define the invoice format for invoices it wishes to receive. The system facilitates routing, editing, dispute resolution, and disbursement of payment. The system includes payer (buyer) shown as 901, payee (vendor) shown as 902, and financial institutions shown as 950. The system has the following characteristics according to one implementation: collaborative network model, A/P (buyer) centric enterprise software, plugging into existing ERP systems, full cycle bill-to-pay functionality, web-based A/R (vendor) software, and co-existence with the customer existing bank relationships.

The collaborative network model supported by the unique collaborative vendor reconciliation engine between global directory shown as 928 and A/P centric master vendor list shown as 927. The reconciliation engine provides methods of matching existing vendor name/address with self enrolled vendor information in the global directory. These methods include: fuzzy attributed weight based matching shown as 930, previous vendor histories of matching in the knowledge based shown as 931, third party outsourced recommended matching proposal shown as 932, and manual interactive selection from buyers shown as 933. Each vendor is represented by several critical attributes in the global directory: addresses shown as 938, real and alias accounts shown as 939, and keys shown as 940. Vendor entries are pre-populated with information uploaded from the buyer ERP system. The vendor enrolls via the online self-service enrollments 935. Vendor also provides additional rules to match 934, A/R remittance format attributes 936, and notification rules/addresses 937.

Accounts payable (A/P) buyer-centric enterprise software associated with payer system 901 includes several key unique functions. These functions include buyer defined electronic invoice exchange, routing/editing and approval, and dispute resolution. Payer system 901 includes invoice definition engine 903, invoice 904, HR organization data 908, routing/editing logic 905, dispute logic 909, notifications logic 912, disbursement logic 913, dynamic terms logics/offers 960, discount logic 916 and settlement logic 917. Also included on payer system 901 are input output (I/O) 910, processor 911, entity key 915, and payer central repository database 927. The invoice definition engine 903 includes validation logic 953, tolerance/replacement items 955, interaction severity 954, and several presentation forms 956. This definition engine is controlled by payer helps provide clean invoice data from payees. The definition logics (953, 954, 955, and 956) can be configured to specific payee or a specific group of payees.

Invoice definition engine 903 and its definition logics are exposed to payee via global directory and are operative with invoice definition/generation/validation 918 of payee system 902. The routing/editing logic 905 includes business logic that governs how an invoice will be processed by AP clerks, and what data entry information will be required to complete the transaction. Routing/editing logic 905 can operate differently based on multiple attributes: document type, document value, discount value, etc. Routing/editing logic 905 acts on HR organization database 908 to define routing/editing/approval work flow based on employee information 907 and role values 906. Invoice 904 is coupled into routing logic 905. Routing logic 905 is coupled with employee logic 907 and role assignment 906. Routing logic 905 is coupled with HR data 908 and with dispute logic 909, notifications logic 912 and disbursement logic 913 of payer system 901. Notification logic 912 is configured by the payer, and includes collaborative filtering, and mappings status and notification definitions between internal to external payees. These collaborative filtering and mappings can be designated to a payee or a group of payees.

Dispute logic 909 is set of payer defined centric collaboration rules and interactions between payer and payee to resolve issues related to invoice or other exchanged documents. Some disputes are simple (e.g., number of items is received, etc.) while others are more complex (e.g., replacement items do not meet part specification and price). The outcomes of a dispute are partial payments, partial invoices, new invoices, or other outcomes. According to one implementation, a dispute can only be finalized by payer and its members, and some finalized exchanges will require digital signature to ensure non-repudiation. The payer dispute logic 909 orchestrates with payee dispute logic 922. Payer dispute logic, references, and history are stored in payer central repository 927.

A/R web based centric software associated with payee system 702 helps provide an online self-service payee system. Payee system 702 includes a processor 952 and input/output (I/O) 951. Such processor 952 and input/output 951 allow for communication with other entities such as payer system 901, financial institutions 950 and global database 928. Processor 952 and processor 911 of payee 902 and payer 901 respectively may run various software processes to implement the logic shown. The processes may be implemented as software objects, routines or other software processes, programs or implementations. Alternatively, portions of such logic may be implemented in hardware logic or other forms of logic. The functions shown may alternatively be implemented on a common server or in a distributed set of computer systems separated over a computer network, or other configuration that achieves the logical functions shown. Data and information such as for global database 928 may be stored in data structures or other data format and stored in computer memory, fixed storage or other data storage or archived in various implementations of the invention.

Payee system 902 includes invoice generation/validation logic 918, invoice send logic 921, dispute logic 922, notifications logic 923, receipt/validation logic 924, discount logic 925 and settlement logic 926. Invoices or other documents can be submitted to payer via multiple mechanisms. Three sample mechanisms are shown here: Web forms shown 957, purchase order pre-populated invoice (PO flip) 958, and electronic file submission via file mapping 919. The Web forms 957 are a set of payer defined presentations that can be selected and/or authorized to be used by payee(s). Payee can also define additional payee private attributes and fields to be used during A/R matching as well as graphic materials (such as company logo, etc.). The PO flip 958 uses information from purchase orders which are transmitted to payee from payer to pre-populate the invoice data. The status of each purchase order is maintained within the payee central repository to support blanket purchase orders. File mapping 919 is used by the payee to automate the bulk invoice submission process. Normally, these file are exported from payee's A/R system. The mapping defines how payee's data will be mapped into payer, as well as default/validation/transformation rules. Upon submission of these invoices or other documents via multiple mechanisms (957, 958, 919). The documents are validated based on the payer definition engine 918. This definition engine 918 includes payer definition engine 903 and its components: validation 953, severity 954, tolerance 955 and presentation 956.

Invoice generation/validation logic 918 is coupled with mapping logic 919 in communication with file data 920. Invoice generation/validation logic 918 is coupled into invoice send logic 921. Dispute logic 922 is coupled with dispute logic 909 of payer system 901. Notifications logic 923 is in communication with notifications logic 912 of payer system 901 and discount logic 925 of payee system 902. Receipt/validation 924 of payee system 902 is in communication with disbursement module 913 of payer system 901. Settlement logic 926 is operative with discount logic 925 of payee system 902 and receipt/validation logic 924.

Global database 928 is available to notifications logic 912 and 923, disbursement logic 913, settlement logic 917 and 926, invoice send logic 921, receipt 921 and receipt/validation logic 924. Global database 928 is in communication with payer database 927 through attribute match rules 930, knowledge based history matching samples 931, third party recommendation/proposal 932 and manual interactive matching by payers 933. Global database 928 is in communication with payee database 929 through match rules 934, enrollment logic 935, remittance formats 936 and notification preferences 937. Global database includes items such as address 938, accounts 939 and public keys 940. Payer database 927 is located with payer system 901 and payee database 929 is located with payee system 902. Global database 928 is also available to financial institutions 950.

Through invoice definition engine 903 a payer uses payer system 901 to define the invoice that the payer wishes to receive. Such definition helps to increase efficiency in the payer system because the resulting invoice from the payee, such as a seller, is more likely then in the proper data format when it is received. Payee system 902 generates an invoice based on the defined invoice in invoice generation/validation logic 918. The input data for the invoice is validated based on the invoice definition rules defined in payer system 901. If file data is used to automatically map into an invoice, such mapping is performed in one embodiment of the invention by mapping logic 919. Mapping logic 919 receives the file data 920 with information to be populated into respective invoices. File data 920 may contain files with data for invoices for various payers who have purchased good or services from the payee. When an invoice is completed it is sent through invoice send logic 921 to payer system 901. Additional information regarding definition of invoice by the buyer and use of related invoice rules is contained in United States patent application entitled System and Method for Electronic Payer (Buyer) Defined Invoice Exchange, application Ser. No. ______, invented by Duc Lam, Ramnath Shanbhogue, Immanuel Kan, Bob Moore and Xuan (Sunny) McRae, attorney docket number 25923.706, which is incorporated herein by reference in its entirety.

An invoice is received at payer system 901 as shown here with invoice 904. The invoice is routed to the respective employees or other agents for its review and approval. Some approval may require additional signatures according to one embodiment of the invention. As shown here, employee logic 907 is in communication with routing logic 905 to allow an employee to authorize, audit or view respective invoice or check information.

Routing logic 905 is also used to route checks or other documents to various employees for signature or approval using HR data 908. Routing logic 905 uses HR data 908 to determine the correct employees to whom to route the respective document, such as in an invoice or check. Routing may be made to the manager of a respective employee if the employee has not responded in a certain time to the document. Such the choice of such manager to whom to route is made based on the management hierarchy in the organization stored in HR database 908. Such database is extracted from a human resource management system (HRMS), in one implementation of the invention.

A user of payer system 901 may dispute an invoice or other payment request through dispute logic 909. Dispute logic 909 is in communication with dispute logic 922 of payee system 902. This allows for communication regarding a dispute between a payer and a payee. The dispute may be only initiated and finalized by a payer. According to one embodiment of the invention, the dispute may be finalized only by the buyer, or the payer system. The dispute includes the capability to indicate that particular items in an invoice are disputed, such as the tax. The dispute logic 909 and 922 include the capability for individuals using the payer system 901 using payee system 902 to engage in a chat dialog. For additional discussion regarding electronic dispute resolution in such a system, refer to United States patent application entitled Method and System for Buyer-Centric Dispute Resolution in Electronic Payment System, application Ser. No. ______, invented by Due Lam, Celeste Wyman and Xuan (Sunny) McRae, attorney docket number 25923.708, which is incorporated herein by reference in its entirety.

Notifications logic 912 communicates completion of various stages of approval or other issues of status regarding invoices and disbursement. For example, when an invoice is approved notifications logic 912 communicates a notification to notifications logic 923 of payee system 902. Based on such notifications, a discount may be enabled through discount logic 916, which is in communication with discount logic 925 of payee system 902. For example, where an invoice is approved, a discount may be enabled based on an agreement or outstanding dynamic terms offers shown as 960 that the corresponding payment is made earlier than required under the original terms and conditions. Dynamic terms are additional real-time terms, a set of rules, and/or goal seeker that are established by payer 960 or payee 961. These dynamic terms rules 960 and 961 are based on business event types (invoice approval, purchase order approval, etc.), a payee or group of payee and a set of new discrete or variable terms. These dynamic term goal seekers allow payer and payee to set desirable outcomes. These dynamic terms can be pre-negotiated up-front or in real-time based on business event types. The approval of these new terms may require digital signature of either payer or payee. Also, third party financial institutions could be involved to provide funding for payee in returns for early discounts. For additional information regarding discounts facilitated by the system, dynamic terms (960 and 961) and discount logic 916 and 925 please refer to US patent application entitled System and Method for Varying Electronic Settlements between Buyers and Suppliers with Dynamic Discount Terms, application Ser. No. ______, invented by Don Holm, Duc Lam and Xuan (Sunny) McRae, attorney docket number 25923.705, which is incorporated herein by reference in its entirety.

To facilitate complete bill-to-payment functionality, the system in FIG. 9 includes disbursement logic 912 and settlement logic 917. Disbursement logic 913 includes all payment routing, signing, and approval logic for respective invoices or other requirements for payment. Some payments will require multiple signatures to be signed based on payment amount and/or destination payee(s). Digital signatures and nondigital signatures may both be used. Also, payer can configure to control new settlement date for the payment by defined payee group and number of business/calendar days to be adjusted. The disbursement logic also includes auditing capability with multiple levels based on number of signatures and/or amount. In one implementation, disbursement logic 913 makes such disbursement in the form of electronic checks in one implementation. Such electronic checks are generated and signed with a digital signature. The digital signature may be obtained from respective users such as through a routing process using routing logic 905 to obtain a signature from employee logic 907 with role assignment digital key 906.

Alternatively, a set of instructions may be received to send a set of checks that use a digital signature of the payer organization rather than the digital signature of an employee. Such check processing may be accomplished through batch processing logic 914 and disbursement logic 913. Such batch processing logic 914 uses an entity key 915, which is a private key of the payer's organization. Batch processing logic 914 requires particular authorization for the respective instruction. The authorization may require that the agent requesting the set of checks sign the instruction with the agent's private key. Receipt/validation logic of payee system 902 is in communication with disbursement logic 913. Receipt/validation logic 924 receives payment, such as in the form of electronic checks. Such electronic checks are validated to assure that they are accurate. Receipt/validation logic decrypts any encrypted documents, for example if the electronic checks are encrypted with the public key of payee system 902, such checks are decrypted. Additionally, the digital signature of the sender is authenticated in receipt/validation logic 924. Such authentication is accomplished using the public key of the payer, which corresponds to the private key of the payer's organization (entity key 915) that was used in batch processing logic 914 (entity key 915). Additionally, verification may be made against a payment database generated by the payer system when the checks are created in order to assure that the checks were actually sent by the payer system. Additional information regarding disbursement 913 and batch processing 914 is contained in United States patent application entitled System and Method for Electronic Authorization of Batch Checks, application Ser. No. ______, invented by Due Lam, Matthew Roland and Xuan (Sunny) McRae, attorney docket number 25923.704, which is incorporated herein by reference in its entirety.

Settlement logic 917 allows for settlement of payment between a payer system 901 and payee system 902. Settlement mechanism includes exiting combination of paper based checks, standard domestic electronic payment network (Fed Wire, ACH, CHIPS, etc.), international electronic payment networks (SWIFT, Bolera, etc.), propriety private payment networks (VISA, MasterCard, and American Express, etc.), and internal account bank transfer (On-us, etc.) For example, settlement may be made through debits and credits in a database within the system. Alternatively, settlement may be performed through an external network such as the ACH network with financial institutions involved, such as financial institutions 950.

Settlement logic 917 supports standard fund transfer model (buyer's account will be debited and supplier's account will be credited.) and good funds model (buyer's account will be debited and a temporary account will be credited. Upon receiving fund availability in temporary account, the supplier will be credited). Settlement logic 917 is implemented via issuing requests to the settlement network. Such request can be file-based requests such as ACH or transactional request such as VISA networks. For each request, there will be associated confirmation ID to ensure the trace ability of each transaction.

Global database 928 is available for use by elements that send payment, such as disbursement logic 913 and settlement logic 917. Global database 928 is also available for elements that send other documents or information between payees and their respective financial institutions. For example, invoices may be sent based on the respective recipient address as stored in the global database 928. Thus, invoice sends logic 921 is in communication with global database 928.

Global database 928 includes addresses and account information for respective payers and payees who use the system. Links are created between items in the global database and other databases in order to allow for the global database to be updated and the corresponding linked information to continue to be used. Thus, for example, according to one embodiment of the invention, a payer has a separate database, payer databases 927, and matches are created between items, such as addresses or payment entities and payer 927 and respective items in global database 928 through a match generation process 930. Such matched generation process 930 may include providing a user of the payer system 901 with a series of candidate matches between addresses stored on payer database 927 and corresponding spellings of addresses or payment entities in global database 928. The user of payer system 901 is then able to select the best match and create a link between the respective address or payment identification.

This link can then later be used to effect payment to the proper address as stored in the global database. Similarly, a match generation between items in payee database 929 and global database 928 can be performed so that payee system 902 can send items to the proper recipient using information in global database 928. Enrollment logic 935 is available to enroll new entities as payees into the global database to make them available for use by payer system 901 or payee system 902.

The links established are then available to allow for use of information in the respective payer database 927 and payee database 929 in order to find recipients to whom documents or payments are to be sent. In addition to address information 938 and account information 939, according to one embodiment of the invention, public keys of various participants in the systems are stored in the global database 928. Such keys are then available for use in order to determine the accuracy of a digital signature sent by a particular entity. Additional information regarding global database 928 and related logic and communication is contained in the United States Patent Application entitled Method and System for Collaborative Vendor Reconciliation, application Ser. No. ______, invented by Due Lam, Georg Muller, Chandra (CP) Agrawal, Baby Lingampalli, Pavel Lopin and Xuan (Sunny) McRae, attorney docket number 25923.703, which is incorporated herein by reference in its entirety.

In the FIG. 9 system, invoices and other documents are exchanged between payers and payees over the public and internet networks 980. To help provide security and privacy, before they are sent, invoices and other documents are signed with source private key, and encrypted with destination public key shown as 981. Upon receiving invoice or other document, the document is decrypted with its own private key, and validated against source public key to ensure non-repudiation shown as 982.

The system also can integrate with multiple enterprise resource planning (ERP) systems shown as 962. Such ERP systems include: PeopleSoft, SAP, Oracle Financials, etc. The system will integrate with these ERP systems via native and/or standard interfaces. An example of native interface for PeopleSoft is Message Agent, etc. The interfaces include EDI gateway, etc. The system utilizes the ERP to extract documents (purchase orders, invoice status, unit of measurements, vendor list, etc.), to post documents (invoices, vendor information, status, etc.).

The foregoing description of various embodiments of the invention has been presented for purposes of illustration and description. It is not intended to limit the invention to the precise forms described.

What is claimed is:

1. A method for effecting a transaction between two parties comprising:
receiving electronic data regarding management relationships between respective employees at one of the parties;
receiving from the other party an electronic document related to the transaction;
providing an interface through which users can take actions with respect to documents, wherein the actions include authorization of invoices and applying signatures to checks;
sending a notification regarding the document to an electronic mail account of a user who is responsible for at least an aspect of the transaction; and
if the user does not take a particular action within a particular period, automatically sending the invoice to the user's manager as determined based on the electronic data.

2. The method of claim 1, wherein the electronic data comprises data loaded from a human resources management system.

3. The method of claim 1, wherein the document comprises an invoice and the particular action comprises approval of the invoice.

4. The method of claim 1, including presenting the employee a link to a page in which the employee can take action on the invoice.

5. The method of claim 1, wherein user comprises the employee who ordered goods that are included in the transaction.

6. The method of claim 1, wherein the signatures comprise digital signatures effected with a private key.

7. The method of claim 1, including automatically displaying the documents in a user interface listing the documents wherein the display is based on priority.

8. The method of claim 7, wherein the documents are prioritized based on discount day.

9. The method of claim 7, wherein the documents are prioritized based on the due date.

10. The method of claim 1, including:
receiving an identification of a contact person, and if the person is not found, automatically routing to an account for the contact person's department, and
if the department is not found, automatically routing to an account for an accounts payable department.

11. The method of claim 1, including
if the document is an invoice and it matches an open purchase order, determining whether prices in the invoice are within a range of tolerances associated with the purchase order and automatically approving the invoice if prices in the invoice are within the tolerances.

12. A system for effecting a transaction between two parties comprising:
means for receiving electronic data regarding management relationships between respective employees at one of the parties;
means for receiving from the other party an electronic document related to the transaction;
means for providing an interface through which users can take actions with respect to documents, wherein the actions include authorization of invoices and applying signatures to checks;
means for sending a notification regarding the document to an electronic mail account of a user who is responsible for at least an aspect of the transaction; and
means for, if the user does not take a particular action within a particular period, automatically sending the invoice to the user's manager as determined based on the electronic data.
